(19) United States
(12) Patent Application Publication
(10) Pub. No.: US 2004/0151349 A1
(43) Pub. Date: Aug. 5, 2004

(54) Method and or system to perform automated facial recognition and comparison using multiple 2D facial images parsed from a captured 3D facial image

(76) Inventors: Donald A. Milne III, Rockville, MD (US); Jonathon Vu, Fairfax, VA (US)

Correspondence Address: DEWITT ROGGIN PLLC, 12 E. LAKE DRIVE, ANNAPOLIS, MD, 21403, US

(21) Appl. No.: 10/757,144

(22) Filed: Jan. 14, 2004

Related U.S. Application Data
(60) Provisional application No. 60/440,338, filed on Jan. 16, 2003.

(51) Int. Cl. G06K 9/00

(52) U.S. Cl. 382/115; 382/181

(57) ABSTRACT

A method to perform a facial recognition and comparison computer system using multiple 2D facial images, which were parsed from a captured 3D facial image, is disclosed. The parsed 2D images facial recognition computing system's architecture and implementation allow the use of parsing 3D facial images into multiple 2D facial images at different angles; the use of a commercial off the shelf (COTS) application/algorithm for facial recognition to digitize these 2D images into strings of binary data for comparison with others within a 2D facial images database; and the high speed data comparison obtained by using a memory resident relational database management system. Specifically, the accuracy of the facial image search and the processing speed of a database query, and data display will be substantially increased with the available multiple facial images at different angles while by taking advantage of the speed of RAM (Random Access Memory).

### CROSS-REFERENCE TO RELATED APPLICATIONS

This application claims the benefit of U.S. Provisional Application Serial No. 60/440,338 filed on Jan. 16, 2003 by inventors Donald A. Milne, III and Jonathon Vu.

Related Application: U.S. patent application Ser. No. 10/347,678, entitled Memory-Resident Database Management System and Implementation Thereof; Filed on Jan. 22, 2003; Attorney Docket Number 0299-0005; Inventors: Tianlong Chen, Jonathan Vu.

### STATEMENT REGARDING FEDERALLY SPONSORED RESEARCH OR DEVELOPMENT

Not applicable.

### BACKGROUND OF THE INVENTION

1. Field of the Invention

The present invention relates broadly to image data comparison, and more particularly to facial image recognition.

2. Brief Description of the Related Art

Typical applications today store and compare facial images in either 3-Dimensional (3D) or 2-Dimensional (2D) form. Specifically, 3D methods or systems typically capture images using two or more cameras. By using two or more cameras, the systems or methods capture depth and surface view data. Depth and surface view data is used to construct the image in 3D. The system or method then compares the image to other images within a 3D image database. A 2D method or system typically captures images using one or more cameras to capture the target face data. The system or method then digitizes the image for comparison with other images within a 2D image database.

Two-dimensional facial recognition methods include eigenface methods, local feature analysis, and automatic face processing. Images taken in two dimensions, however, are highly sensitive to view angle, light conditions and changes in facial accessories, e.g., beard, glasses, etc. Thus, using 2D images in a real-world environment often results in an unacceptably high error rate. Since 2D facial scan solutions historically have had accuracy and/or reliability problems, 3D images have been preferred over 2D images for facial recognition.

One advantage of using a 3D facial recognition system over a 2D facial recognition system is its accuracy. It is well documented that 3D technology is more accurate in identification than 2D imaging. 3D systems have been known to accurately identify a person in the 90th percentile. The disadvantage of a 3D system over a 2D system is its speed of data search and image comparison. Basically, 3D image data files typically are much larger than 2d image data files. The large sizes of the 3D files result in processor (CPU) intensive usage for computational construction of the 3D images. The large file sizes likewise require greater processing time to digitize the image into strings of data. Further, while large databases of 2D facial images of known or suspected criminals and terrorists exist today, no 3D image databases of comparable numbers of images exist today. Thus, time needed to digitize the image and the data volume of data within a 3D image database combine to form a slowly processing system. In current systems, to run a 3D image comparison and return a result can take 20 minutes or more.

Image recognition is used in environments where maintaining security is very important, and must be done quickly. For example, an image recognition system would be used in an airport to compare the images of people present in the airport to images of known or suspected terrorists. If the image comparison is done too slowly, a known or suspected terrorist might be able to board an airplane or otherwise leave the area before any comparison results were processed and acted upon. Time is an important factor when maintaining security. Thus, a slow-functioning 3D image recognition system is highly undesirable for performing image recognition in the real world and/or in real time.

Databases of images of known or suspected criminals and terrorists currently exist. Of the available databases, 2D image databases are quite extensive. 3D image databases, on the other hand, are not as extensive or prevalent. Thus, the databases largely existing for image recognition systems to use do not afford great accuracy.

### SUMMARY OF THE INVENTION

The present invention has been made in view of the above circumstances. The present invention is related to combining 3D and 2D technologies to capture a 3D facial image; to parse the 3D facial image into multiple 2D facial images at different angles; to store the data in the system server memory, or other memory device; to use a 2D facial recognition application to digitize and to compare the multiple 2D facial images across the 2D facial images within a database; and to return the matched result.

This system will allow the image capturing computers to capture and to enroll the 3D facial images; to parse the 3D image into multiple 2D facial images at various angles; to store into its solid state memory device such as its hard drive; to send these 2D facial images at various angles into a high memory bank server for digitization; to compare the image with other 2D facial images within a 2D facial image database; and finally to return the match result to the query PC in a near real-time solution.

Infrastructure wise, the system will function within a network including the Client Personal Computers (PC), various types of Servers, and various types of commercially available digital video equipment including visual optical digital cameras, digital video camcorder, infrared cameras, webcams, and other video equipment accessories.

The present invention relates to a combined 3D and 2D system and method for identifying a person more accurately while performing search functions at a near real-time speed. 2D images may be put into a string of data for faster data search in memory, specifically in Random Access Memory (RAM) or Read Only Memory (ROM), and thus the data search exceeds a rate of over 1 million images per second. Unless otherwise specified, the term “memory” used herein refers to RAM, ROM, or other varieties of chip-based memory.

One aspect of the present invention is a method of facial recognition and matching system using both 3D and 2D facial recognition systems, and included are diverse high-speed search technologies, which may include Ram Resident Relational Database technology.

In still another aspect of an embodiment of the present invention, a method of combining 2D and 3D facial recognition systems to ensure accuracy and processing speed to identify a person in a near real-time is described.

In still another aspect of an embodiment of the present invention, a method of segregating the 3D image capture process, which may be processor intensive, from remaining processes to store and to search for a match in a 2D database of images is described.

In still another aspect of the present invention, a system and method of Network Component Connectivity architecture amongst the individual computers within a network to collectively pool and share a large amount of 2D images parsed from individual 3D images for storage, retrieval, comparison and display is disclosed.

Still another aspect of an embodiment of the present invention is a method of image storage and management for a system using both 3D and 2D images is described.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention.

Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRITION OF THE DRAWINGS

For a more complete understanding of the present invention and the advantages thereof, reference is now made to the following description and the accompanying drawings, in which:

FIG. 1 illustrates an embodiment of a facial recognition system of the present invention.

FIG. 2 illustrates an embodiment of a 3D image capture portion of the present invention. FIG. 3 illustrates an embodiment of a 2D image identification portion of the present invention.

FIG. 4 illustrates a sample of a 2D image comparison application output used in an embodiment of the present invention.

FIG. 5 illustrates a server process of an embodiment of the present invention.

FIG. 6 illustrates a data flow diagram for a 3D image capture process in an embodiment of the present invention. FIG. 7 illustrates a data flow diagram for a 2D image comparison process in an embodiment of the present invention. FIG. 8 illustrates an embodiment of an image capture process of the present invention.

### DETAILED DESCRIPTION OF THE PREFERRED EMBODIMENTS

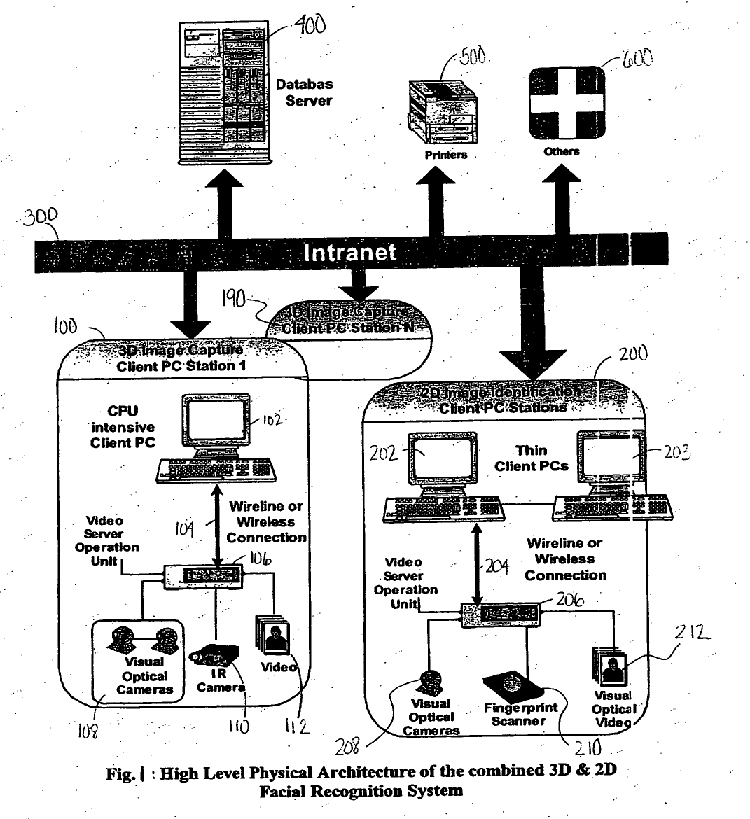

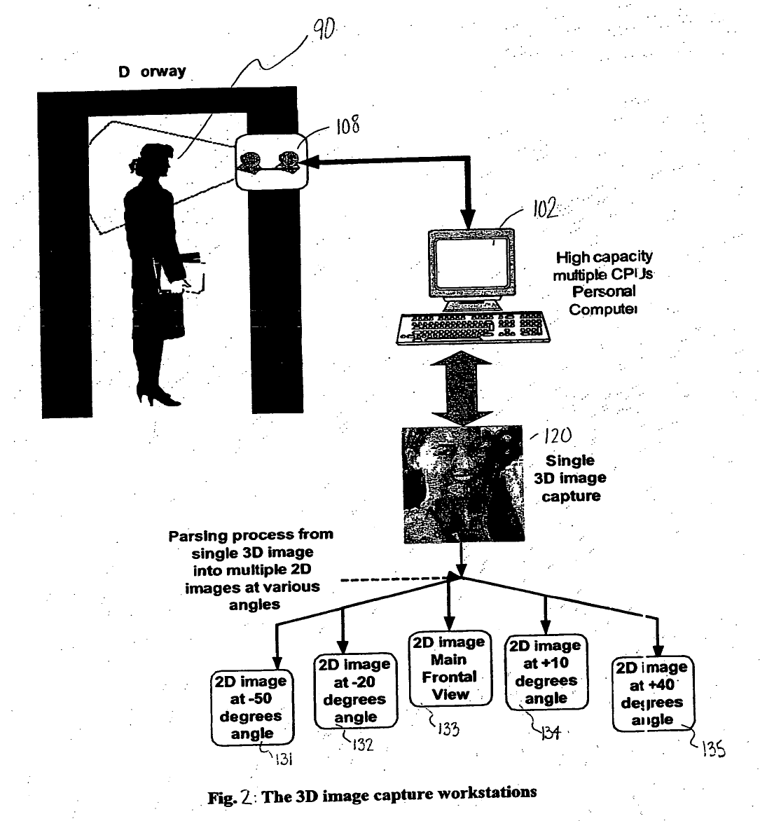

Referring to FIG. 1, an embodiment of a facial recognition system of the present invention is illustrated. The system is composed of Personal Computer hardware, multiple video equipment and accessories, 3D image software including 3D image capture functions and image parsing functions. The facial recognition system uses multiple 2D facial images, which are parsed from a captured 3D facial image; and system architecture components, e.g., network, servers and client personal computers, and the like.

Still Referring to FIG. 1, a 3D image capture station 100, up to N image capture stations 190, and at least one 2D Image Comparison station 200 are connected to a network 300. These stations 100, 190, 200 communicate with a database server 400, other peripherals 500, and other locations 600 including computers, printers, and the like, that send and receive image recognition data.

In the 3D image capture station 100, image peripherals 108, 110, 112 are connected to a server 106. 3D Image peripherals 108, 110, 112 capture 3D images of bio-identifiers, for example facial images. A variety of peripherals may be used with the present invention to capture 3D images, for example, visual optical cameras, Infra-Red cameras, finger print scanners and/or video cameras. Images are transmitted from the image peripherals 108, 110, 112, through a server 106, to one or more 3D image capture stations 100, 190. 3D image capture stations 100, 190 capture and construct 3D images, and parse 3D images into a number N of 2D images at various angles.

The 3D image capture stations 100, 190 include COTS image recognition software. 3D image capture software is well known. A4 Vision of Cupertino, Calif., for example is but one many sources of 3D image capture software.

In the 2D Image Comparison station 200, 2D image peripherals 208, 210, 212 capture 2D images are connected to a server 206. 2D Image peripherals 208, 210, 212 capture 2D images of bio-identifiers, for example facial images. A variety of peripherals 208, 210, 212 may be used with the present invention to capture 2D images, for example, visual optical cameras, Infrared cameras, finger print scanners, and/or video cameras. 2D Images are transmitted from the 2D image peripherals 208, 210, 212, through a server 206, to one or more 2D image identification stations 202, 203. 2D image identification stations 202, 203 digitize 2D images and process comparisons of 2D images.

The 2D image identification stations 202, 203 include COTS image recognition software. 2D image capture software is well known. Viisage Technology, Inc., of Littleton, Mass., for example, offers face-recognition technology, using the “eigenfaces,” method, which maps characteristics of a person's face into a multi-dimensional face space. Other types of 2D image capture software and systems are known and widely available.

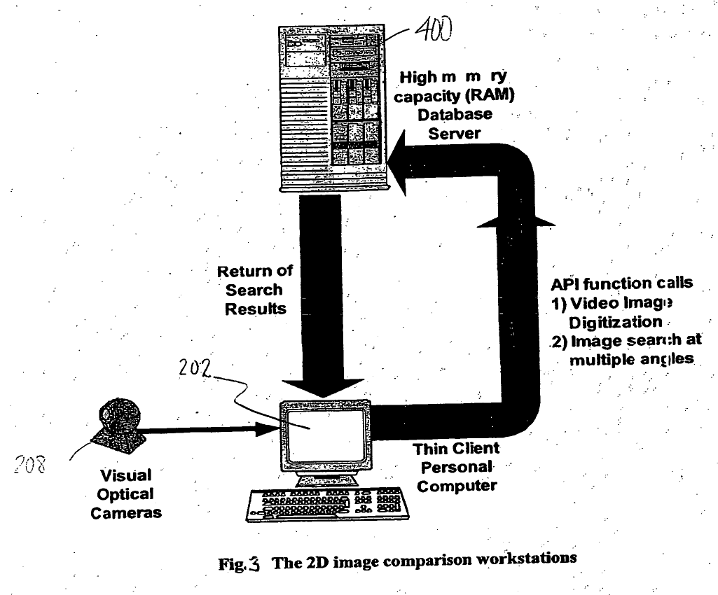

FIG. 2 illustrates an embodiment of a 3D image capture portion of the present invention. A person's facial image 90 is captured by a 3D Image peripheral 108. The facial image 90 is transmitted to a 3D image capture station 102. The 3D image capture station 102 captures and enrolls the 3D facial images 90. Next, the 3D image capture station 102 parses the 3D image 120 into multiple 2D facial images at various angles 131, 132, 133, 134, 135. The multiple 2D facial images at various angles 131, 132, 133, 134, 135 are stored, for example, into a solid state memory device such as the hard drive of the 3D image capture station 102.

FIG. 3 illustrates a 2D image comparison portion of the present invention. The 2D Image peripheral 208 transmits a 2D image to the 2D image identification station 202. The 2D image identification station 202 registers, stores, and processes comparisons of 2D images. An image to be stored or searched is transmitted to the Database server 400. The Database server 400 digitizes 400 the image. If the image has been searched, the Database server 400 runs the search and compares the image to those stored in the database. The Database server 400 then returns the search result to the 2D image identification station 202. The 2D image video image identification system of FIG. 3 may be composed of all Commercial Off-the-Shelf (COTS) products.

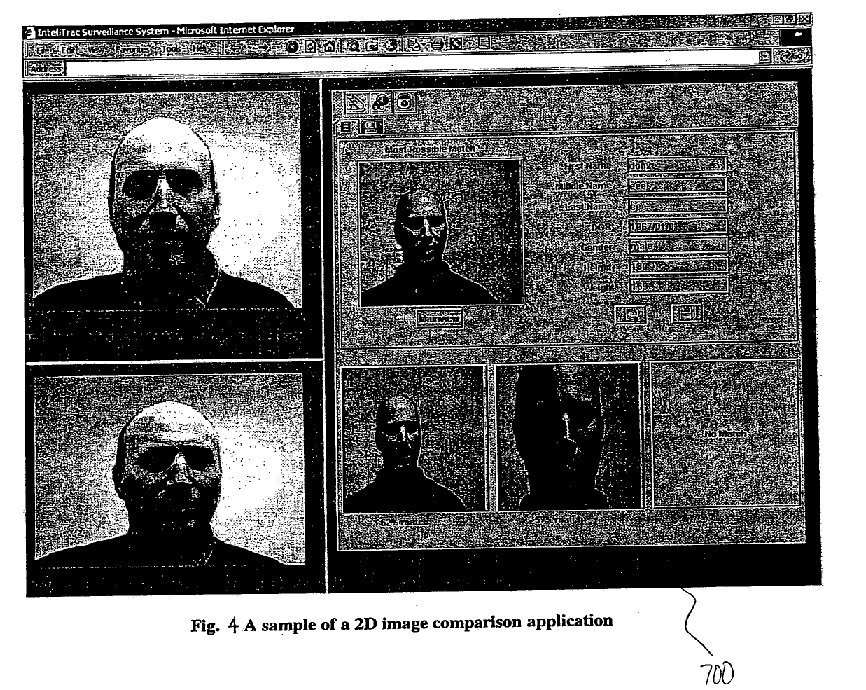

FIG. 4 illustrates a sample of a 2D image comparison application. This view illustrates a search 700 viewed at the 2D image identification station 202, as illustrated in FIG. 3.

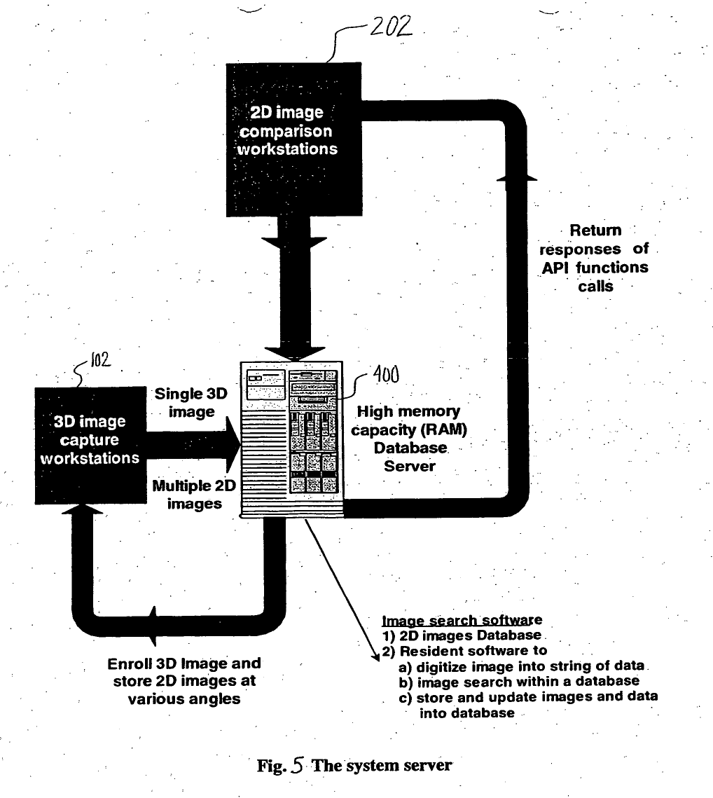

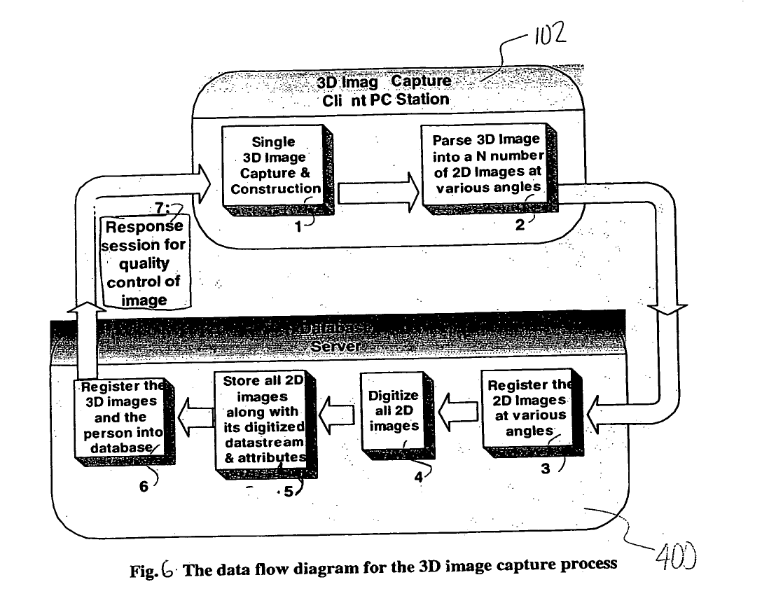

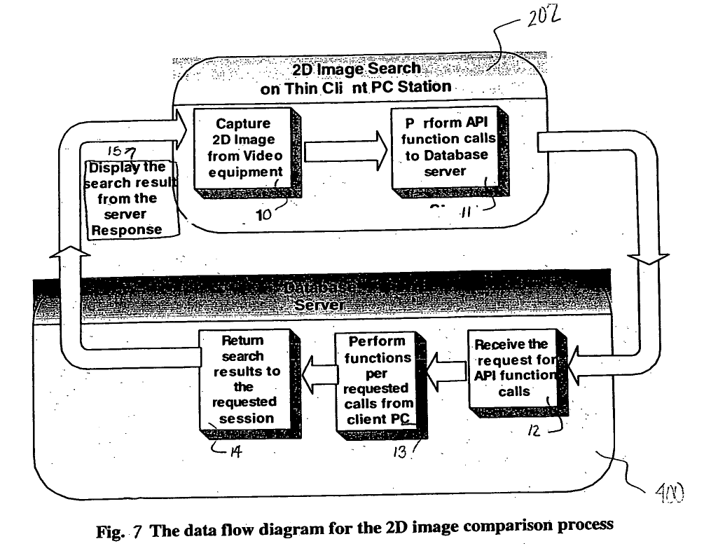

FIG. 5 illustrates a conceptual block diagram of the system server 400. Such system is composed of all Commercial Off-the-Shelf (COTS) products including a high memory based server as hardware, network connectivity to the client PCs, data storage in memory software, 2D image software including 2D image digitization, storage and comparison functions. The 3D image capture station 102, captures and enrolls the 3D facial images 90, parses 3D images into multiple 2D facial images at various angles. The 2D image identification station 202 registers, stores, and processes 2D images. The 2D and 3D images are transmitted to the Database Server 400. The Database Server 400 stores, updates, and manages images in a database. When a search request comes in to the Database Server 400, the Database Server 400 digitizes the image and runs the search. Results are sent back to the requesting 3D image capture 102 or 2D image comparison 202 workstation.

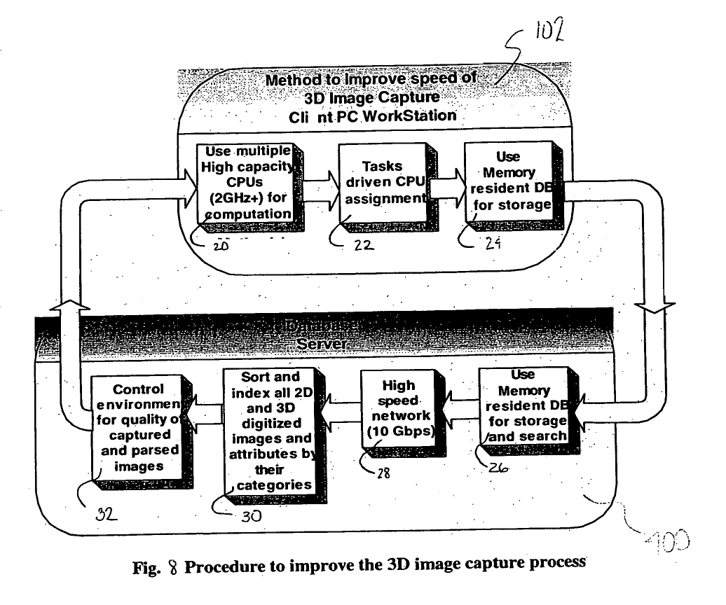

FIG. 6 illustrates a data flow diagram of the 3D image capture process. A 3D image capture station 102 receives a single 3D image 1. The 3D image capture station 102 parses the 3D image into a plurality of 2D images taken from various angles 2. The parsed, 2D images are sent to the Database Server 400. The Database server 400 registers the parsed 2D images in its database 3, and digitizes all the 2D images 4. Each 2D image is stored with its digitized file stream and any attributes 5. When a search query is run, the database server 400 compares the 2D images for matches. If a 2D image match is found, the database server reconstructs the 3D image from the parsed, 2D images 6. The reconstructed 3D image is compared to the original image to determine whether a quality image has been generated 7.

FIG. 7 illustrates a data flow diagram of the 2D image comparison process. The 2D image comparison workstation 202 receives a 2D image from 2D image peripherals 10. Search requests are sent from the 2D image comparison workstation 202 to the Database Server 400. The Database Server 400 receives the search request 12, performs the search 13, and returns the search results 14 to the requesting 2D image comparison workstation 202. The search results are displayed 15 at the workstation 202.

FIG. 8 illustrates an embodiment of the 3D image capture process. A 3D image capture station 102 uses high speed CPUs, i.e., with processing speeds of at least 2 Gigahertz to process image capture and image parsing functions 20. The CPU assignments are task-driven 22. Image data is stored at the 3D image capture station 102 in a Memory Resident Database, i.e., a database stored in RAM 24. The Database Server 400 distributes image data over a high-speed network to other sources of memory for storage 28. The Database server 400 sorts and indexes 2D and 3D images according to their attributes and categories 30. Images retrieved during a search are compared to the original image to determine whether a 3D image has been reconstructed 32. Search results are returned to the requesting 3D image capture station 102.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. An image recognition system comprising:
means for capturing a three dimensional image;
means for parsing said three dimensional image into a plurality of two-dimensional images; and
means for comparing at least two of said two-dimensional images to a database of a plurality of two-dimensional images.

2. An image recognition system according to claim 1 further comprising:
means for displaying a result of said comparison.

3. An image recognition system according to claim 1, wherein said means for comparing comprises:
means for digitizing a two-dimensional image.

4. An image recognition system according to claim 3 wherein said means for comparing further comprises:
means for storing a digitized two-dimensional image.

5. An image recognition system according to claim 4, wherein said means for comparing further comprises:
means for searching a database of two-dimensional images.

6. An image recognition system according to claim 1, wherein said means for capturing a three dimensional image comprises at least one of a visual optical digital camera, a digital video camcorder, an infrared camera, and a webcam.

7. An image recognition system according to claim 1, wherein said means for capturing a three dimensional image comprises:
a fingerprint scanner.

8. An image recognition system according to claim 1, wherein said means for comparing comprises:
a server.

9. An image recognition system comprising:
an image peripheral;
a processor system connected to said image peripheral, wherein said processor system constructs and captures a three dimensional image from signals received from said image peripheral, parses said three dimensional image into a plurality of two-dimensional images, and compares at least two of said plurality of two-dimensional images to a database of two-dimensional images.

10. An image recognition system according to claim 9 wherein said processor system comprises a server.

11. An image recognition system according to claim 9 wherein said processor system comprises:
a first processor for constructing and capturing a three dimensional image from signals received from said image peripheral and for parsing said three dimensional image into a plurality of two-dimensional images; and
a second processor for comparing at least two of said plurality of two-dimensional images to a database of two-dimensional images.

12. An image recognition system according to claim 11 wherein said first processor and said second processor are connected to each other through a network.

13. An image recognition system according to claim 12 wherein said network comprises a high-speed network.

14. An image recognition system according to claim 9 wherein said image peripheral and said processor system are connected to each other through a network.

15. An image recognition system according to claim 11 wherein said second processor comprises a server.

16. An image recognition system according to claim 9, wherein said image peripheral comprises at least one of a visual optical digital camera, a digital video camcorder, an infrared camera, and a webcam.

17. An image recognition system comprising:
an image capture station for capturing three dimensional images, said image capture station comprising an image peripheral, a first processor, and a first memory, wherein said image capture station stores a three dimensional image captured by said image peripheral in said first memory and said processor parses said three dimensional image into a plurality of two dimensional images; and
an image identification station, connected to said image capture station, comprising a second processor and a second memory, wherein said image identification station receives said plurality of two-dimensional images from said image capture station and compares said plurality of two dimensional images to a database of two dimensional images.

18. An image recognition system according to claim 17 further comprising an intranet; wherein said image capture station and said image identification station are connected to each other through said intranet.

19. An image recognition system according to claim 18 wherein said intranet comprises a wireless network.

20. A method of identifying images comprising the steps of:
capturing a three-dimensional image;
parsing said three-dimensional image into a first plurality of two-dimensional images; and
comparing at least two of said first plurality of two-dimensional images to a second plurality of two-dimensional images.

21. A method of identifying images according to claim 20 further comprising the step of:
displaying a result of said comparison.

22. A method of identifying images according to claim 21 further comprising the step of storing said captured three-dimensional image in a database.

23. An image recognition system comprising:
an intranet;
a database server connected to said intranet;
a 3D image capture station connected to said intranet, said 3D image capture station comprising a CPU and an image peripheral; and
a 2D image identification station connected to said intranet, said 2D image identification station comprising a CPU;
wherein said 3D image capture station captures a three dimensional image, parses said three dimensional image into a plurality of two dimensional images, and transfers at least two two-dimensional images parsed from said three-dimensional image to said 2D image identification station.

24. An image recognition system according to claim 23, wherein said 3D image capture station further comprises a video server connecting said image peripheral to said CPU.

25. An image recognition system according to claim 23, wherein said 2D image identification station compares said at least two two-dimensional images received from said 3D capture station to a plurality of known two-dimensional images.

26. An image recognition system according to claim 24 wherein said video server is connected to said CPU through a wireless connection.

27. An image recognition system according to claim 24 wherein a plurality of image peripherals are connected to said CPU through said video server.
